(19) United States
(12) Patent Application Publication
(10) Pub. No.: US 2014/0291219 A1
(43) Pub. Date: Oct. 2, 2014

(54) VESSEL BASED MARINE WATER EVAPORATION SYSTEM

(71) Applicant: CHRISTOPHER M. EGER, PITTSBURGH, PA (US)

(72) Inventor: CHRISTOPHER M. EGER, PITTSBURGH, PA (US)

(21) Appl. No.: 14/215,138

(22) Filed: Mar. 17, 2014

Related U.S. Application Data
(60) Provisional application No. 61/786,777, filed on Mar. 15, 2013.

(51) Int. Cl. B01D 1/20; C02F 1/04

(52) U.S. Cl. CPC B01D 1/20; C02F 1/048; C02F 2103/008
USPC 210/143; 210/180; 210/177

(57) ABSTRACT

An evaporator system for evaporating wastewater comprises an evaporation chamber; a heat exchanger disposed within a hollow interior of the evaporation chamber; a spray pump and at least one spray nozzle for spraying the wastewater onto the exterior surface of the heat exchanger; a control apparatus configured to control the operation of the heat exchanger, the spray pump and the evaporation chamber; a housing; and a power source. The heat exchanger may comprise at least one hollow body that has a wall with an exterior surface and an interior surface, a first opening at a first end of the at least one hollow body, a second opening at a second end of the at least one hollow body.

### CROSS-REFERENCE TO RELATED APPLICATIONS

This application is related to and claims priority from U.S. Provisional Patent Application Ser. No. 61/786,777 filed on Mar. 15, 2013 and from U.S. Provisional Patent Application Ser. No. 61/933,986 filed on Jan. 31, 2014.

### FIELD OF THE INVENTION

The present invention relates, in general, to a wastewater treatment and, more particularly, the instant invention relates to a marine wastewater evaporation system and, yet more particularly, the invention relates to a vessel based marine water evaporation system that disposes of marine wastewater in an environmentally friendly, energy efficient, and cost efficient manner.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, the treatment and disposal of wastewater, and in particular, contaminated wastewater, has proven to be a difficult task to perform and enforce in practice. While this is true in the average case, it is particularly true for the treatment of contaminated wastewater produced on transportation vessels such as marine vessels.

A marine vessel, when in operation, produces large quantities of wastewater that must be treated and/or stored until the vessel reaches port. The alternative is for the vessel to dispose of the wastewater overboard and into the body of water through which it is travelling.

Marine vessel wastewater can be divided into broad categories. The first results from human activity on board the vessel and includes “black water” and “grey water”. Black water is a term used to describe wastewater containing fecal matter and urine. Black water contains pathogens that must decompose before they can be released safely into the environment. It is difficult to process black water if it contains a large quantity of excess water, or if it must be processed quickly, because of the high concentrations of organic material. Grey water is typically understood to be wastewater produced as a result of cooking, cleaning, washing and other personal activities and generally contains the residues of washing processes. The second category of wastewater on a marine vessel is typically understood to be “bilge water” which includes liquids and particulates that accumulate in the bilge as a result of activities relating to the operation and maintenance of a vessel.

Bilge water constitutes all water that makes its way into the bilge of the vessel. Water can find its way into the bilge in a number of fashions, including water from leaking pipes, valves and pumps, water that may enter the engine room from the propeller tail shaft, water leaks from equipment located in the engine room, process water used to wash the engine room and other industrial areas of the marine vessel, turbid or brackish water drawn onboard from ports and harbors and even some grey water, all of which may find its way into the bilge. The resulting accumulation of water in the bilge is typically contaminated with lubricating oil, fuel oil and other debris from the engine room.

There is a need for an improved system to dispose, by way of an evaporation, the wastewater including at least one of a portion of bilge water, gray water and treated black water coming off of Marine Sanitation Devices (MSD) allowing workboats, barges and even shore facilities to become no discharge zones.

### SUMMARY OF THE INVENTION

The present invention provides an evaporator system for evaporating wastewater comprising an evaporation chamber; a heat exchanger disposed within a hollow interior of the evaporation chamber; means for spraying wastewater onto the exterior surface of the heat exchanger; a control apparatus; a housing and a power source. The heat exchanger includes at least one hollow body that has a wall with an exterior surface and an interior surface, a first opening at a first end of said at least one hollow body configured to receive a flow of a fluid therethrough, a second opening at a second end of said at least one hollow body configured to evacuate said flow of said fluid from said at least one hollow body, and whereby a portion of a heat energy in said fluid is transferred through said wall to said exterior surface thereof. Additionally, the means for spraying the wastewater onto the exterior surface of the heat exchanger includes a spray pump, at least one spray nozzle, connected to the spray pump in a fluid communication therewith and configured to spray the wastewater onto the exterior surface of the hollow body. The wastewater is converted into vapors upon a contact with the exterior surface of the wall due to the heat energy transfer. The vapors are evacuated from said evaporation chamber. The control apparatus includes one or more sensors, automatic valves and a controller in operative communication with said one or more sensors, and said automatic valves, whereby said control apparatus is configured to control an operation of said heat exchanger, said means for spraying the wastewater and said evaporation chamber. The housing houses the heat exchanger, the evaporation chamber, and the controller.

The fluid of the evaporator system of the present invention may be one of an air or a liquid. The evaporator system of the present invention may also include a positive pressure chamber including a positive pressure pump, a positive pressure air inlet for receiving atmospheric air, and a positive pressure outlet.

The evaporation chamber of evaporation system of the present invention may also include an evaporation chamber air outlet valve configured to release said evaporated waste water.

In one embodiment, the at least one hollow body of the heat exchanger of the evaporation chamber extends along a longitudinal axis of the heat exchanger and includes a first opening and a said second opening that are tapered. Additionally, the hollow body may include a mounting flange at each end of the hollow body in operative alignment with a respective tapered opening.

The evaporatoration chamber of the evaporation system may include a vacuum pump; an input vacuum valve that generates a vacuum on the evaporation chamber, and an output vacuum valve to release evaporated wastewater.

In an alternative embodiment, the evaporation chamber may include a positive pressure chamber, including a positive pressure pump, a positive pressure air inlet for receiving atmospheric air, a positive pressure outlet; and a positive pressure chamber connector for connecting said positive pressure pump to said evaporation chamber that comprises at least one hollow body having an interior and an exterior surface and at least one opening on said hollow body for forcing air into said evaporation chamber.

Yet an alternative embodiment of the present invention is directed to a vessel based evaporator system for evaporating marine wastewater. The vessel based evaporator includes an evaporation chamber; a heat exchanger disposed within a hollow interior of the evaporation chamber; means for spraying the wastewater onto the exterior surface of the heat exchanger; a positive pressure chamber; a positive pressure chamber connector for connecting the positive pressure pump to the evaporation chamber; an evaporation chamber air outlet valve configured to release the evaporated wastewater; a control system; a housing and a power source. The heat exchanger may include at least one hollow body that has an exterior surface and an interior surface, a first opening at a first end of said at least one hollow body for receiving waste heat from an engine on the vessel, and a second opening at a second end of the at least one hollow body, whereby the waste heat enters the at least one hollow body through the at least first opening and flows through the at least one hollow body in direct connection with the interior surface and exits through the second opening. The waste heat increases the temperature of both the interior surface and the exterior surface of the hollow body. Further, the means for spraying the wastewater onto the exterior surface of the heat exchanger may include a spray pump, and at least one spray nozzle, connected to the spray pump in a fluid communication therewith, for spraying said wastewater generally directly onto the exterior surface of the hollow body, such that the wastewater evaporates due to elevated temperatures of the exterior surface of the at least one hollow body. The positive pressure chamber may include a positive pressure pump, a positive pressure air inlet for receiving atmospheric air, and a positive pressure outlet. The positive pressure chamber connector for connecting the positive pressure pump to the evaporation chamber that may comprise at least one hollow body having an interior and an exterior surface and at least one opening on said hollow body for forcing air into said evaporation chamber. The control system comprising one or more sensors, automatic valves and a controller in operative communication with said one or more sensors, said automatic valves, and said positive pressure pump, whereby said control system is configured to control operation of said heat exchanger, said positive pressure pump and said evaporation chamber. In this particular embodiment, the housing may be configured to house the heat exchanger, the evaporation chamber, the positive pressure pump and the controller.

An alternative embodiment may be directed towards apparatus including a heat exchanger; a positive pressure chamber; an evaporation chamber; a control system; and a housing. The heat exchanger may include at least one hollow body that has an exterior surface and an interior surface, a first opening at a first end of the at least one hollow body that is configured to receive waste heat from a heat source, and a second opening at a second end of the at least one hollow body for expelling the heat, whereby the waste heat enters the at least one hollow body through the at least first opening and flows through the at least one hollow body in direct connection with the interior surface and exits through the second opening, wherein the waste heat modulates the temperature of both said interior surface and said exterior surface of the hollow body. The positive pressure chamber may include a positive pressure pump, a positive pressure air inlet for receiving atmospheric air, and a positive pressure outlet. The evaporation chamber may include a positive pressure chamber connector for connecting the positive pressure pump to the evaporation chamber that comprises at least one hollow body having an interior and an exterior surface and at least one opening on said hollow body for forcing air into said evaporation chamber. The evaporation chamber may also include an air outlet valve configured to release the evaporated liquid, and a spray pump that comprises at least one spray nozzle for spraying the liquid generally directly onto the exterior surface of the hollow body, such that the liquid evaporates due to elevated temperatures of the exterior surface of the at least one hollow body. The control system may include one or more sensors, automatic valves and a controller in operative communication with said one or more sensors, automatic valves, and positive pressure pump, whereby the control system is configured to control operation of said heat exchanger, said positive pressure pump and said evaporation chamber. The housing may be configured to house the heat exchanger, the evaporation chamber, the positive pressure pump and the controller. The liquid may be marine wastewater, and the heat source may be an engine of the marine vessel. Additionally, the heat may be an exhaust heat or a coolant from the engine. The apparatus may also include a power source, wherein the power source is a generator.

Yet another embodiment of the present invention is directed towards an apparatus comprising a heat exchanger; an evaporation chamber; a control system; a housing and a power source. The heat exchanger may include at least one hollow body defining a longitudinal axis of said heat exchanger, wherein the at least one hollowed body has an exterior surface and an interior surface, a first tapered opening at a first end of said at least one hollow body that is configured to receive heat from a heat source, a second tapered opening at a second end of the at least one hollow body for expelling said heat, whereby said heat enters the first tapered opening and flows through the at least one hollow body in direct connection with the interior surface of the at least one hollow body and exits through to the second tapered opening, wherein said heat modulates temperature of both the interior surface and the exterior surface of the hollow body. Additionally, the at least one hollow body may include a mounting flange at each end of said hollow body in operative alignment with a respective tapered opening. The evaporation chamber includes a vacuum pump, an input vacuum valve that generates a vacuum in the evaporation chamber, an output vacuum valve configured to release evaporated liquid, and a spray pump that includes at least one spray nozzle for spraying said wastewater generally directly onto said exterior surface of the hollow body, such that said liquid evaporates due to elevated temperatures of the exterior surface of the at least one hollow body. The control system of this particular embodiment may include one or more sensors, automatic valves and a controller in operative communication with the one or more sensors, the automatic valves, and the input and output vacuum valves, whereby the control system is configured to control operation of said heat exchanger and the evaporation chamber. The housing houses the heat exchanger, the evaporation chamber, and the control system. The apparatus of the present embodiment may installed on a marine vessel. The liquid may be marine wastewater and the heat source may be an engine of the marine vessel. The heat may an exhaust heat or coolant from said engine.

An alternative embodiment of the present invention may be directed to a wastewater evaporation system including an evaporation chamber; a heat exchanger disposed within a hollow interior of said evaporation chamber; a means for spraying a wastewater onto an exterior surface of said heat exchanger, whereby a portion of a heat energy in a fluid circulated through a hollow interior of said heat exchanger and transferred to an exterior surface thereof converts the wastewater contacting said exterior surface into vapors; and a means for evacuating said vapors from said evaporation chamber. The means for spraying the wastewater may be disposed within the evaporation chamber and may comprise a pump and at least one nozzle connected, in a fluid communication, to the pump. The wastewater evaporation system of the present embodiment may also include a control apparatus configured to control an operation of the heat exchanger, the means for spraying the wastewater and the evaporation chamber. Additionally, the wastewater evaporation system may further include means for decreasing the temperature level required to convert wastewater into vapors. The means for decreasing the temperature level required to convert wastewater into vapors may include utilizing the positive pressure created by a positive pressure chamber and a means for connecting the positive pressure chamber with the evaporation chamber. The positive pressure chamber of the present embodiment may also include a positive pressure pump disposed within the positive pressure chamber, an air inlet for receiving atmospheric air, a positive pressure outlet, and a connector connecting said positive pressure outlet with an inlet in said evaporation chamber.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

### OBJECTS OF THE INVENTION

It is, therefore, one of the primary objects of the present invention to provide a system for evaporating wastewater, wherein the system includes an evaporation chamber, a heat exchanger, means for spraying the wastewater onto the exterior surface of the heat exchanger, a control system, a housing and a power source.

Another object of the present invention is to provide a vessel based system for treating and/or disposing marine wastewater that comprises an evaporation chamber, a heat exchanger disposed within a hollow interior of the evaporation chamber, means for spraying the wastewater onto the exterior surface of the heat exchanger, a positive pressure chamber, a positive pressure chamber connecter, an evaporation chamber air outlet, a control system, a housing and a power source.

Yet another object of the present invention is to provide a an apparatus that includes a heat exchanger, a positive pressure chamber, an evaporation chamber, a control system and a housing.

A further object of the present invention is to provide an apparatus comprising a heat exchanger, an evaporation chamber including a vaccuum pump and input vaccuum valve, an output vaccuum valve and a spray pump, a control system, a housing and a power source.

Another object of the present invention is to provide a wastewater evaporation system that includes an evaporation chamber, a heat exchanger, a means for spraying wastewater onto the heat exchanger, and a means for evacuating the vapors from the evaporation chamber.

A further object the present invention is to provide a wastewater evaporation system that recirculates spent heat energy to a source thereof.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is one perspective view of a wastewater evaporation system of the present invention;

FIG. 2 is another perspective from view of the system of FIG. 1;

FIG. 3 is one top planar view of the system of FIG. 1;

FIG. 4 is another top planar view of the system of FIG. 1;

FIG. 5 is a side elevation view of the system of FIG. 1;

FIG. 6 is yet another top planar from view of the system of FIG. 1;

FIG. 7 is partial perspective from view of the system of FIG. 1, particularly illustrating a positive pressure chamber connector;

FIG. 8 illustrates one block diagram of the system of FIG. 1.

FIG. 9 is another perspective view of a heat exchanger of the system of FIG. 1;

FIG. 10 is one front view of the system of FIG. 1;

FIG. 11 is one top view of the system of FIG. 1;

FIG. 12 is one side elevation view of the system of FIG. 1; and

FIG. 13 illustrates another block diagram of the system of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

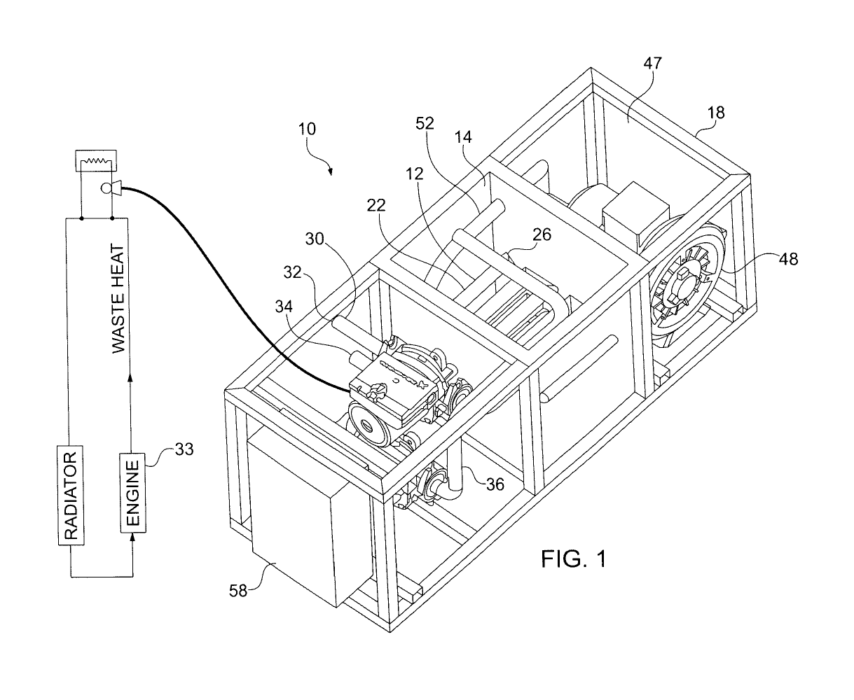

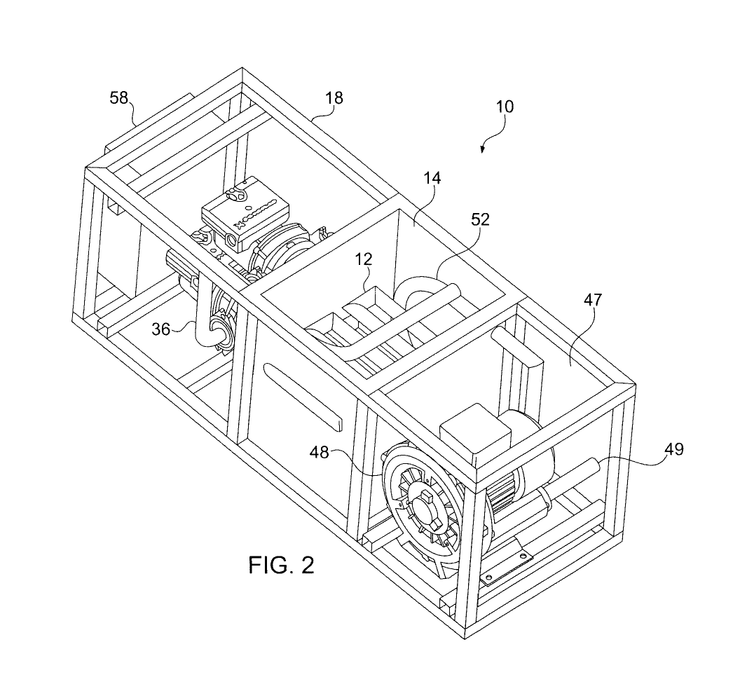

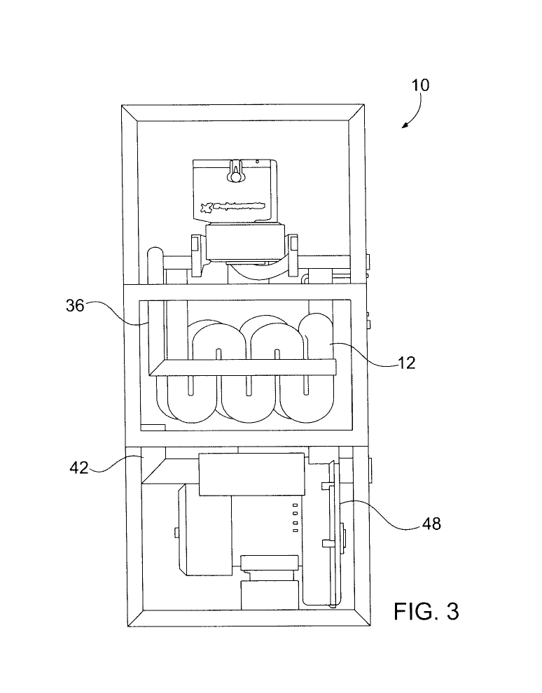

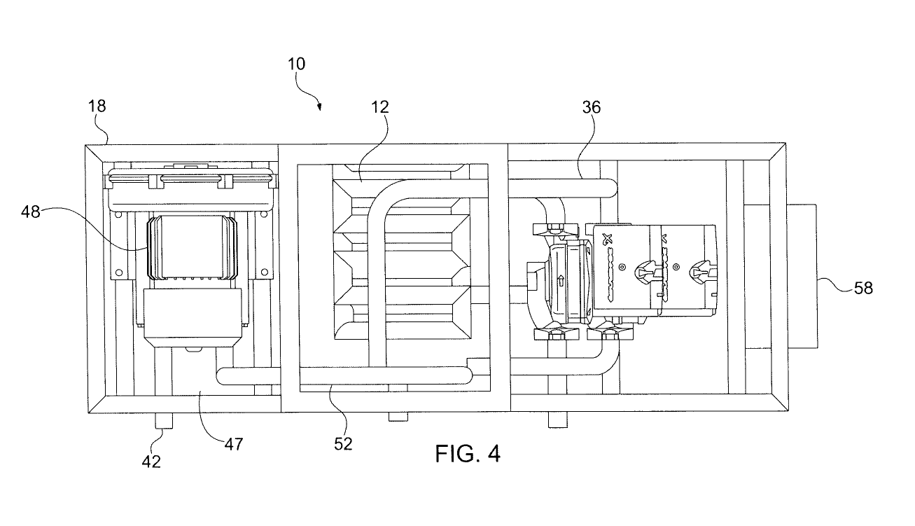

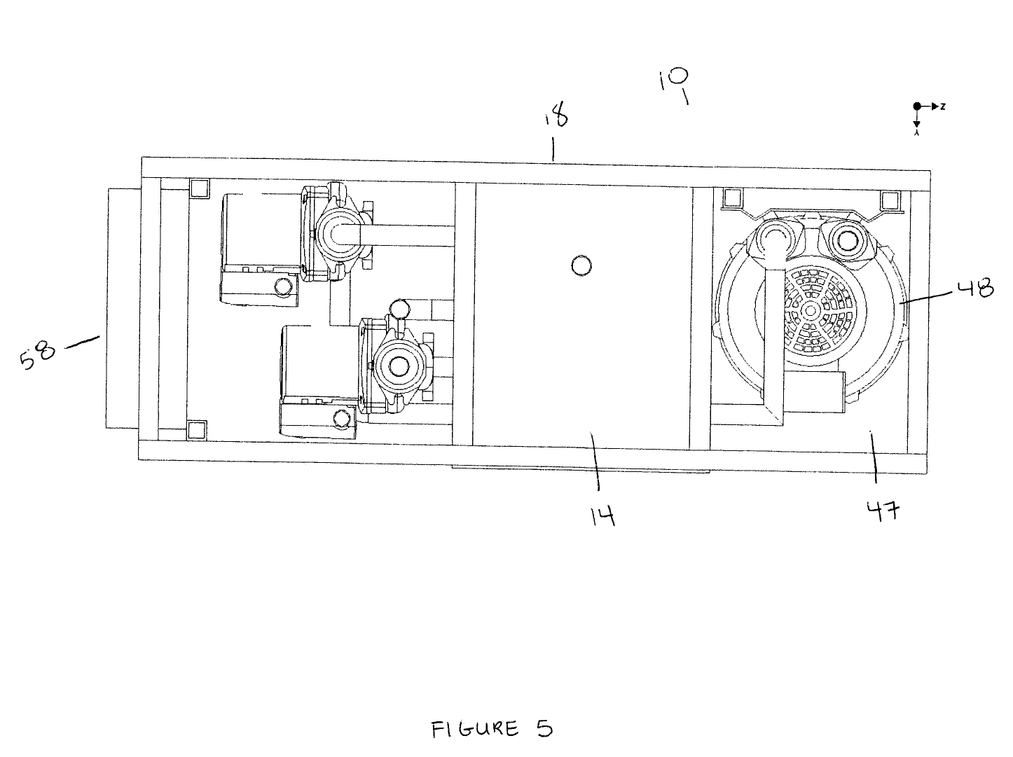

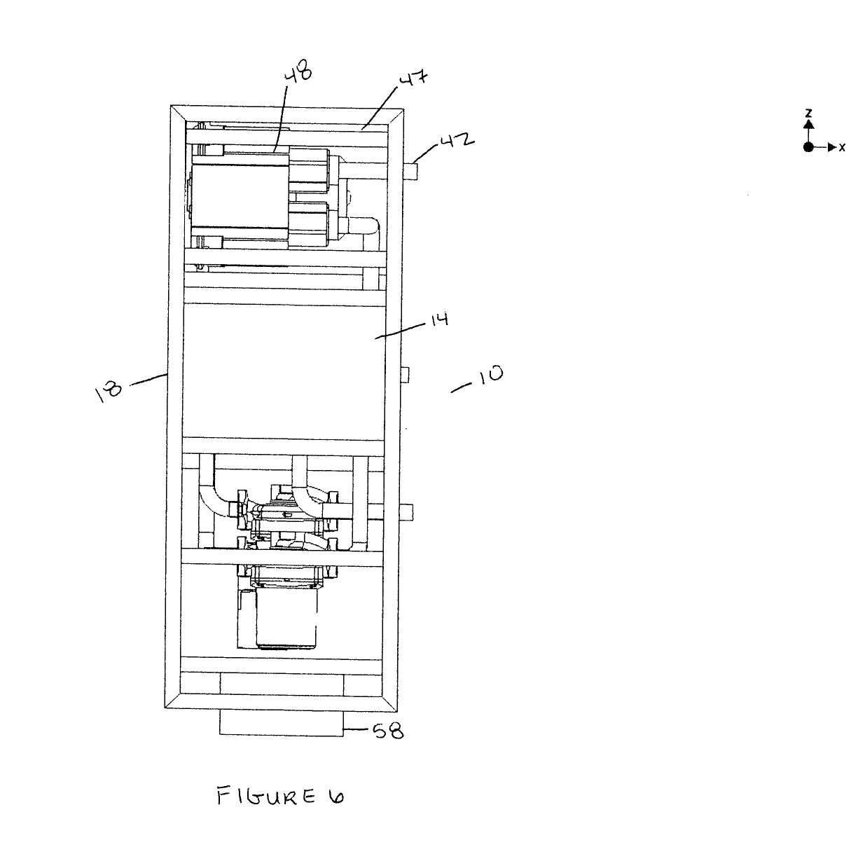

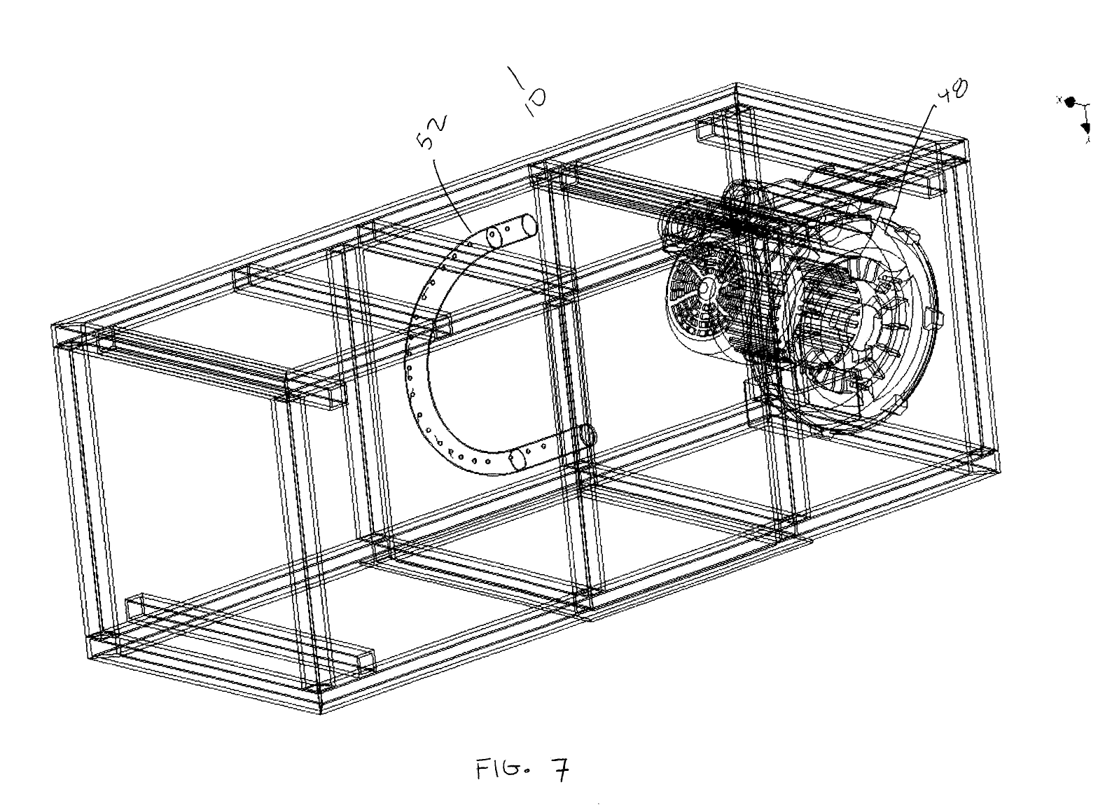

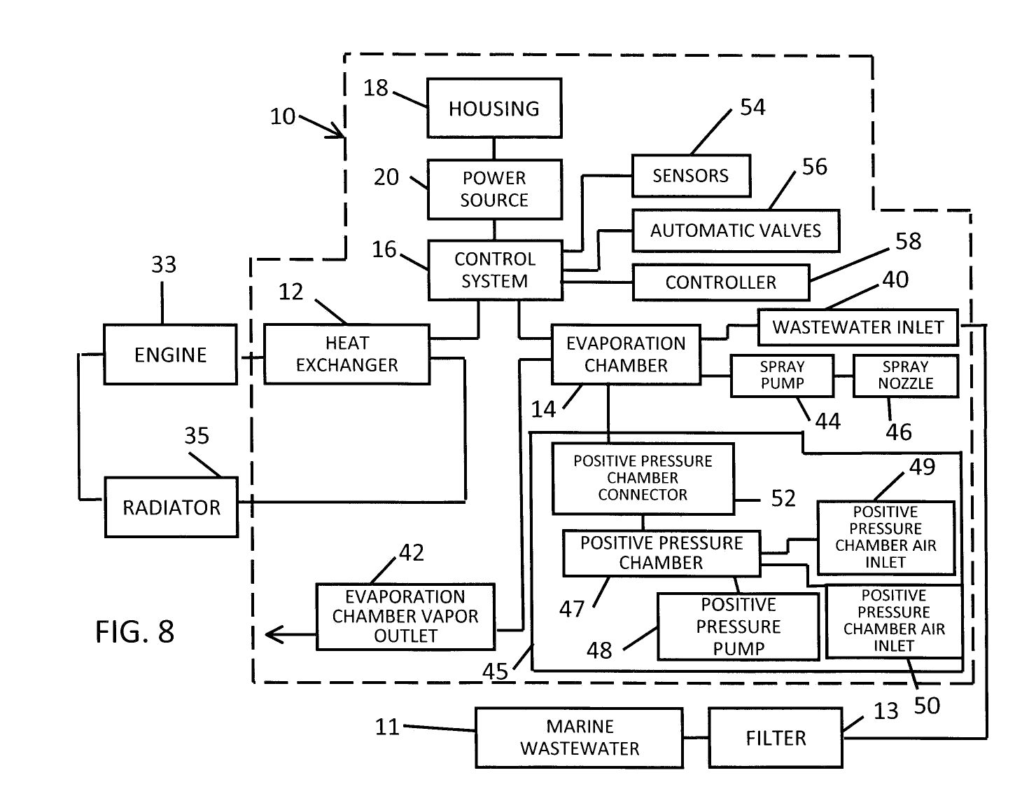

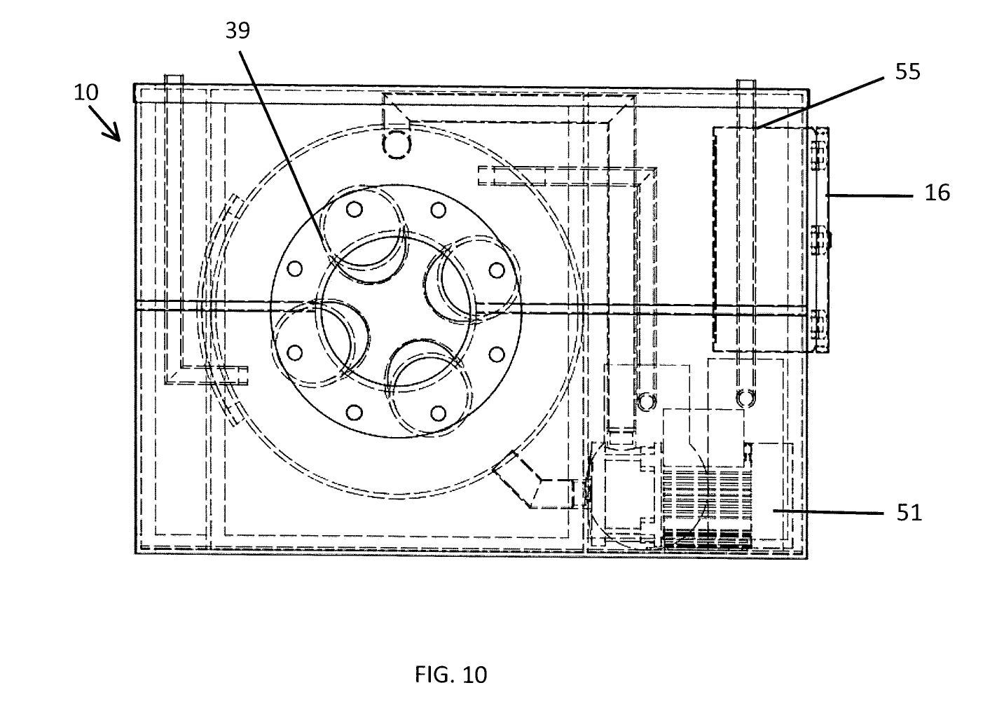

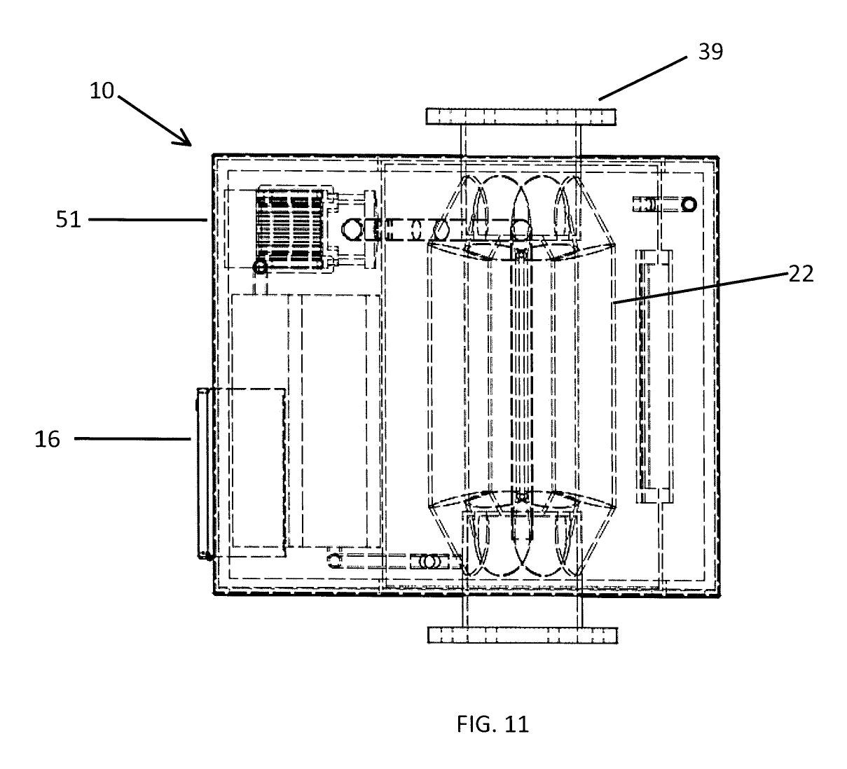

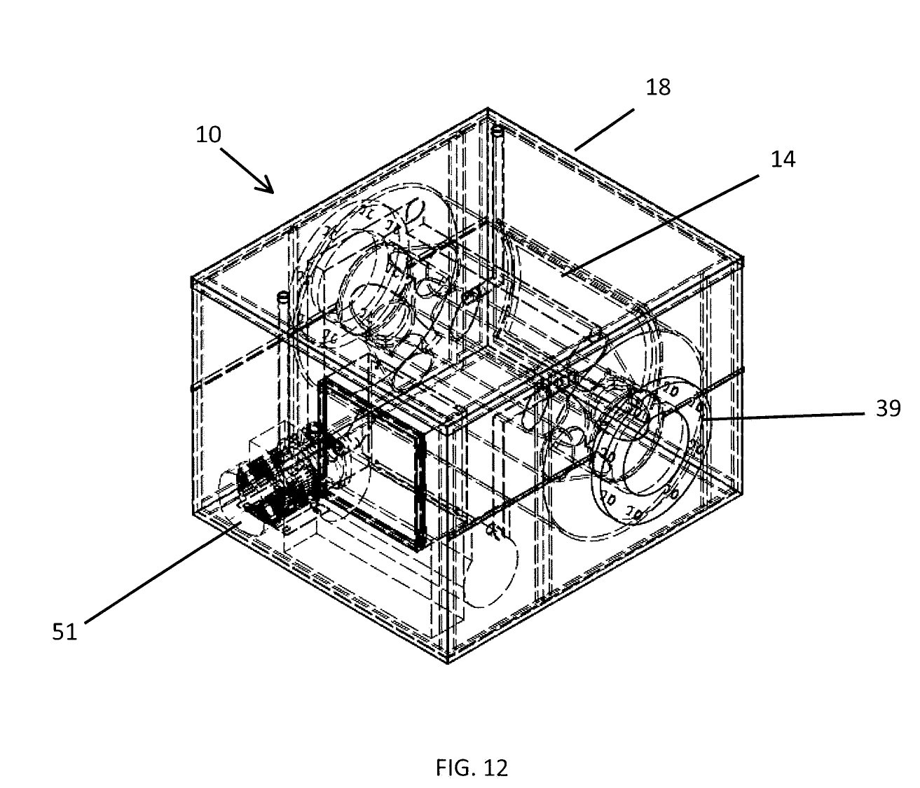

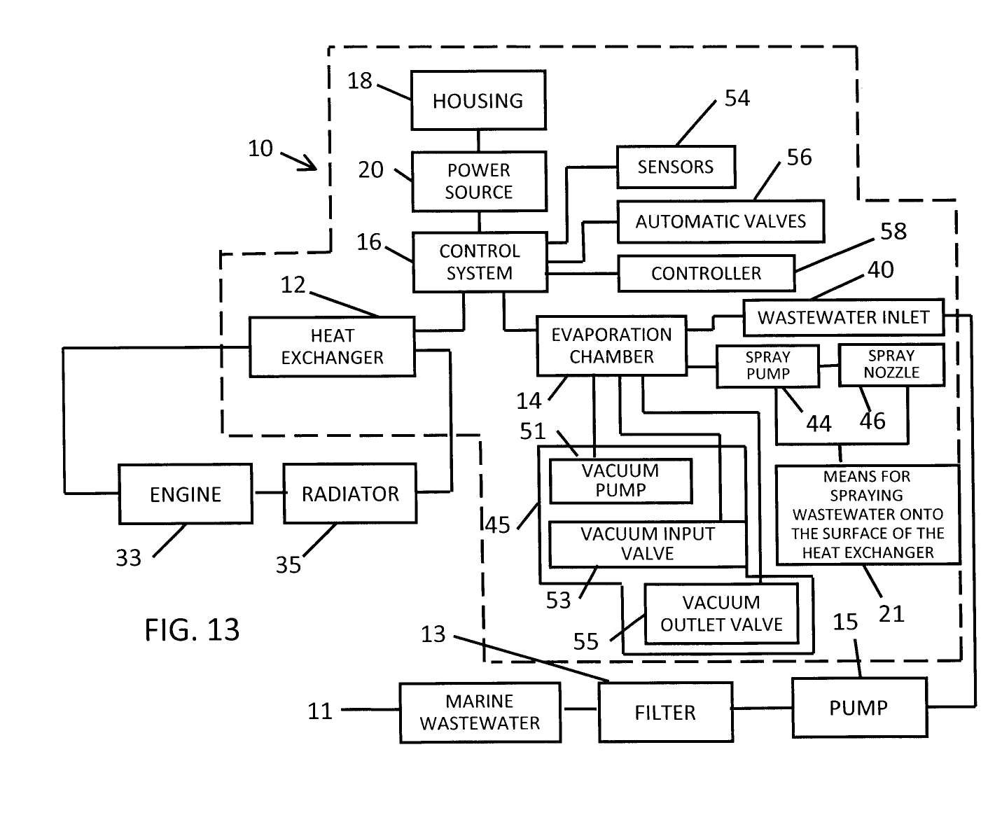

The best mode for carrying out the invention is presented in terms of its presently preferred embodiment, herein depicted within FIGS. 1 through 13. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention describes a method, and system for disposing and/or treating marine wastewater (herein described as the “system”), generally designated as 10, which provides means to evaporate marine wastewater in an environmentally friendly and energy efficient manner.

The present invention is illustrated and described in combination with a marine vessel, although it will be apparent to those skilled in the relevant art that the present invention may be applied other types of transportation vessels or vehicles and as such should not be interpreted as a limiting factor of the system of the present invention.

In a presently preferred embodiment, the instant invention operates on a principle of using a waste heat generated by the operation of the engines on the marine vessel to heat a wall of the hollow body, by passing such waste heat through a hollow chamber thereof, and spray wastewater onto the exterior surface of the body, thus causing conversion of the wastewater into a steam and a subsequent evaporation of the wastewater. The instant invention contemplates an optional means for reducing a boiling point of the wastewater in applications where the temperature of the waste heat is not sufficient alone to heat sprayed wastewater to a boiling temperature so as to cause evaporation thereof. Advantageously, such optional means eliminate a need for a complete absorption of the heat by the wall of the body.

Reference is now made, to FIGS. 1-13, wherein there is shown a system, generally designated as 10, for disposing and/or treating wastewater.

It is to be understood that the definition of wastewater applies to water mixed with waste and the definition of marine wastewater applies to black water, grey water and bilge water.

According to a first embodiment of the invention, as illustrated in FIGS. 1-13, there is provided a system 10 for evaporating wastewater 11. The system 10 includes an evaporation chamber 14, a heat exchanger 12, a control system 16, a housing 18, a power source 20, and means for spraying wastewater onto the exterior surface of the heat exchanger 12.

As previously indicated, the evaporation system 10 for evaporating wastewater 11 may include an evaporation chamber 14. Prior to entry into the system 10 for evaporation, the wastewater 11 may be stored in any suitable storage container. A strainer or filter 13 may be employed prior to the wastewater 11 entering the evaporation chamber 14, such that any solid particulate may be filtered from the wastewater 11 prior to entry into the evaporation chamber 14. In one example, the strainer 13 may be a “Y-strainer.” The wastewater 11 may be transferred to the system 10 using any suitable means, such as a pipe, a hose, or a combination thereof. Additionally, a pump 15 may be employed to move the wastewater 11 from the storage container to the evaporation system 10. The wastewater 11 may enter the evaporation chamber 14 via a wastewater inlet 40. An automatic valve, a float/ball device, a sensor or a combination thereof may control the entry of the wastewater 11 into the wastewater inlet 40.

Additionally, the evaporator system 10 for evaporating wastewater 11 may include a heat exchanger 12 disposed within a hollow interior of the evaporation chamber 14. The heat exchanger may 12 include at least one hollow body 22. The at least one hollow body 22 may have a wall 23 with an exterior surface 26 and an interior surface 28. The hollow body 22 may have a first opening 30 at a first end 32 that is configured to receive a flow of waste heat or waste fluid 25 therethrough. The heat energy in said fluid may be transferred through the wall 23 of the hollow body 22 to the exterior surface 26 thereof.

The hollow body 22 may also include a second opening 34 at a second end 36 of the at least one hollow body 22 configured to evacuate the flow of the fluid from the at least one hollow body 22.

The waste fluid may be one of an air, a liquid or a mixture thereof. In one embodiment, the fluid may be waste heat, for example coolant from a heat source, for example an engine 33 of a vessel (not shown). For example, the waste heat may be directed from the engine 33 to the heat exchanger 12 using any suitable connecting means such as a pipe, a hose or a combination thereof. In one embodiment, a T-connector may be used. The waste heat may enter the heat exchanger 12 through the first opening 30 of the hollow body 22. Once the waste heat has entered the hollow body 22, the waste heat flows through the at least one hollow body 22 in a direct connection with the interior surface 28 of the hollow body 22, thereby increasing the temperature of both the interior surface 28 and the exterior surface 26 of the wall 23 of the hollow body 22.

Once the remaining heat energy exits the heat exchanger 12, the heat energy may be diverted directly or indirectly back to the heat source, for example, an engine 33 of a vessel for reuse by any suitable means such as a pipe, a hose or a combination thereof. Any heat that will reenter the engine 33 may first go through a thermostat to determine if the temperature of the heat is suitable for reentry into the engine 33. If the heat has a temperature above the threshold that is appropriate for reentry into the engine 33, the heat may be directed to a radiator 35 prior to reentry into the engine 33. Therefore, the present invention may also serve as a method and apparatus for regulating the temperature of the waste heat of an engine 33 for reuse in the engine 33, using either the above-described wastewater or any other suitable liquid.

In the embodiment of FIGS. 1-13, the at least one hollow body 22 may be a plurality of hollow bodies to maximize the areas of the exterior surface 24 and the interior surface 26 of the heat exchanger 12, thereby maximizing heat transfer to the wastewater 11 to be evaporated. The hollow bodies 22 may be adjacent with respect to each other, or alternatively, they may be stacked on top of each other.

The hollow body 22 may have any shape, for example a serpentine shape to maximize the area of the exterior surface 26, and the interior surface 26 of the heat exchanger 12, thereby maximizing heat transfer to the wastewater 11 to be evaporated.

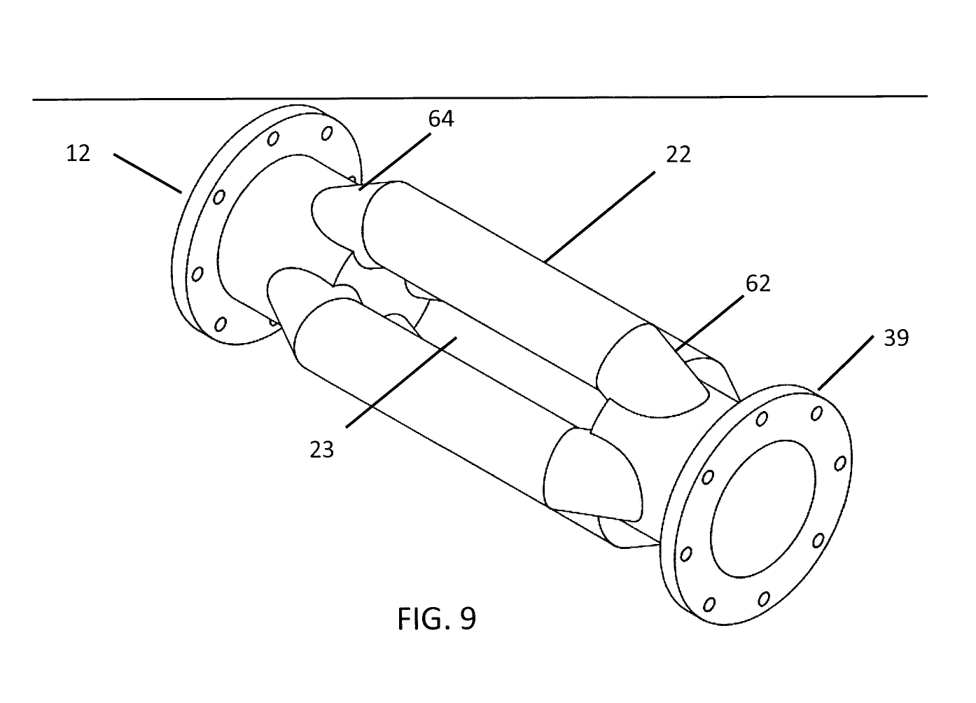

In one particular embodiment of the present invention as seen in FIGS. 9-13, the at least one hollow body 22 of the heat exchanger 12 may extend along a longitudinal axis of the heat exchanger. In this particular embodiment, the first opening of the hollow body 22 and the second opening of the hollow body may be tapered tapered. Additionally, a mounting flange 39 may be configured on each end of the hollow body in operative alignment with a respective tapered opening. In one particular embodiment as seen in FIGS. 9-13, the at least one hollow body 22 may be four (4) hollow bodies.

Additionally, the evaporator system 10 for evaporating wastewater 11 may include means for spraying wastewater 21 onto the exterior surface 22 of the heat exchanger 12 comprising a spray pump 44 and at least one spray nozzle 46 connected in a fluid communication therewith configured to spray the wastewater 11 onto the exterior surface 26 of the hollow body 22. In one embodiment, the invention may include a plurality of spray nozzles 46.

The spray pump 44 and at least one spray nozzle 46 may be positioned within the evaporation chamber 14. Particularly, the spray pump 44 may be a circulation type pump that directs the wastewater 11 that is in the evaporation chamber 14 into the at least one spray nozzle 46 that is positioned adjacent the heat exchanger 12 such that the at least one spray nozzle 46 sprays and/or mists the wastewater 11 onto the exterior surface 26 of the at least one hollow body 22 of the heat exchanger 12, thereby facilitating evaporation. Particularly, when the wastewater 11 is sprayed and/or misted onto the exterior surface 26 of the at least one hollow body 22, the wastewater 11 is converted into vapors upon a contact with the exterior surface 26 of the wall 23 due to the heat energy transfer.

Once the wastewater 11 is converted into vapors, the vapors may be evacuated from the evaporation chamber 14. In one embodiment, the evaporation chamber 14 may further include an evaporation chamber air outlet 42, for removing said evaporated wastewater 11 or vapors from said system 10. The evaporation chamber air outlet 42, may be a valve or a pipe that is in open communication with the atmosphere. For example, if the system 10 is employed on a marine vessel, the marine vessel may include a pipe or hose that is connected to the system, such that said evaporated wastewater can exit the marine vessel. The evaporation chamber air outlet 42 may employ a blower, exhaust fan or other like air movement means to help assist the air in the exiting of the evaporation chamber 14.

The instant invention may further include an optional means for reducing a boiling point of the wastewater 45 during evaporation process. In accordance with one embodiment, the optional means for reducing a boiling point of the wastewater 45 during evaporation process includes a positive pressure chamber 47 having a positive pressure pump 48, a positive pressure air inlet 49 for receiving atmospheric air, and a positive pressure outlet 50. The positive pressure chamber 47 may also include a positive pressure chamber connector 52 for connecting said positive pressure pump 48 to the evaporation chamber 14. The positive pressure chamber connector 52 may include at least one hollow body having an interior and an exterior surface and at least one opening on the hollow body for forcing air into said evaporation chamber. The positive pressure chamber connector 52 may be a pipe, a hose or a combination thereof. Additionally, the positive pressure chamber connector 52 may be any shape, such as straight or curved and the at least one opening on the hollow body may be any shape, such as circular or crescent shaped. The positive pressure chamber connector 52 may further include air valves for assisting and/or regulating the positive pressure airflow into the evaporation chamber 14.

Particularly, the positive pressure chamber 47 and positive pressure pump 48 generates positive pressure in the evaporation chamber 14. The positive pressure generated within the evaporation chamber 14 lowers the boiling point of wastewater 11 below the normal boiling point of water of 212 F, thereby aiding in the evaporation of the wastewater when the temperature of the waste heat is not sufficient alone to elevate temperature of the wastewater 11 to such boiling point.

An alternative optional means for reducing a boiling point of the wastewater 11 during the evaporation process as seen in FIGS. 9-13, may include a vacuum pump 51, a vacuum input valve 53, and a vacuum output valve 55 within the evaporation chamber 14.

The vacuum pump 51, the vacuum input valve 53 and the vacuum output valve 55 generate a vacuum in the evaporation chamber 14 while providing a constant airflow. Particularly, the vacuum pump 51 and the vacuum input vacuum valve 53 generates a vacuum on the evaporation chamber 14 and the vacuum output valve 55 releases evaporated wastewater 11. The vacuum generated within the evaporation chamber 14 lowers the boiling point of water below the normal boiling point of water 212 F, thereby aiding in the evaporation of the wastewater 11.

Additionally, the system 10 for disposing and/or treating wastewater 11 may also include a control apparatus 16 comprising one or more sensors 54, automatic valves 56 and a controller 58 in operative communication with the one or more sensors 54, and the automatic valves 56. The controller 58 may be a relay logic, a computer or a microprocessor, and the control system 16 may be configured to control the operation of the heat exchanger 12, the means for spraying the wastewater 21 and the evaporation chamber 14. In one particular embodiment, the control system 16 may also be configured to control the operation of the positive pressure chamber 47 through the automatic valves 56, specifically automatic adjustable valves that optimizes the heat transfer and boiling temperature of the water. The sensors 54 and the automatic valves 56 of the control system 16 may also control the level of wastewater 11 in the evaporation chamber 14. Specifically, once the wastewater 11 has entered the evaporation chamber 14, the sensors 54 and the automatic valves 56 of the control system 16 may control the level of wastewater 11 in the evaporation chamber 14 and may trigger the starting and stopping of the evaporation system 10 when certain predetermined wastewater 11 levels are reached. Alternatively, a user may control the operation of the evaporation system 10 via the controller 58. For example, the controller 58 may include a user interface wherein the user may determine the operating parameters of the system 10. In one example, the user may determine the when the system 10 is turned on or off.

The system 10 for disposing and/or treating marine wastewater 11 also includes a housing 18 for housing at least a portion of the heat exchanger 12, the evaporation chamber 14, and the control system 16, and the positive pressure chamber 47. The housing 18 may be made of any suitable material. Suitable materials include but are not limited to steel, metal, metal alloys, polymeric materials or any combination thereof.

A power source 20 is also included to power the system 10 for disposing and/or treating marine wastewater 11. In one embodiment of the present invention, the power source 20 may be a combustion source, an electrical source, a battery, a generator on the vessel or any combination thereof.

Another embodiment of the present invention is directed to a vessel based evaporator system for evaporating marine wastewater 11. The vessel based evaporator includes an evaporation chamber 14; a heat exchanger 12 disposed within a hollow interior of the evaporation chamber 14; means for spraying the wastewater 21 onto the exterior surface of the heat exchanger 12; a positive pressure chamber 47; a positive pressure chamber connector 52 for connecting the positive pressure pump 48 to the evaporation chamber 14; an evaporation chamber air outlet valve 42 configured to release the evaporated wastewater 11; a control system 16; a housing 18 and a power source 20. The heat exchanger 12 may include at least one hollow body 22 that has an exterior surface 26 and an interior surface 28, a first opening 30 at a first end 32 of said at least one hollow body 22 for receiving waste heat from an engine 33 on the vessel, and a second opening 34 at a second end 36 of the at least one hollow body 22, whereby the waste heat enters the at least one hollow body 22 through the at least first opening 30 and flows through the at least one hollow body 22 in direct connection with the interior surface 28 and exits through the second opening 34. The waste heat increases the temperature of both the interior surface 28 and the exterior surface 26 of the hollow body 22. Further, the means for spraying 21 the wastewater 11 onto the exterior surface 26 of the heat exchanger 12 may include a spray pump 44 and at least one spray nozzle 46 connected to the spray pump 44 in a fluid communication therewith, for spraying said wastewater 11 generally directly onto the exterior surface 26 of the hollow body 22, such that the wastewater 11 evaporates due to elevated temperatures of the exterior surface 26 of the at least one hollow body 22. The positive pressure chamber 47 may include a positive pressure pump 48, a positive pressure air inlet 49 for receiving atmospheric air, and a positive pressure outlet 50. The positive pressure chamber connector 52 for connecting the positive pressure pump 48 to the evaporation chamber 14 that may comprise at least one hollow body having an interior and an exterior surface and at least one opening on said hollow body 22 for forcing air into said evaporation chamber 14. The control system 16 comprising one or more sensors 54, automatic valves 56 and a controller 58 in operative communication with said one or more sensors 54, said automatic valves 56, and said positive pressure pump 48, whereby said control system 16 is configured to control operation of said heat exchanger 12, said positive pressure pump 48 and said evaporation chamber 14. In this particular embodiment, the housing 18 may be configured to house the heat exchanger 12, the evaporation chamber 14, the positive pressure pump 48 and the controller 58.

An alternative embodiment may be directed towards apparatus including a heat exchanger 12; a positive pressure chamber 47; an evaporation chamber 14; a control system 16; and a housing 18. The heat exchanger 12 may include at least one hollow body 22 that has an exterior surface 26 and an interior surface 28, a first opening 30 at a first end 32 of the at least one hollow body 22 that is configured to receive waste heat from a heat source, and a second opening 34 at a second end 36 of the at least one hollow body for expelling the heat, whereby the waste heat enters the at least one hollow body 22 through the at least first opening 30 and flows through the at least one hollow body 22 in direct connection with the interior surface 28 and exits through the second opening 34, wherein the waste heat modulates the temperature of both said interior surface 28 and said exterior surface 26 of the hollow body 22. The positive pressure chamber 47 may include a positive pressure pump 48, a positive pressure air inlet 49 for receiving atmospheric air, and a positive pressure outlet 50. The evaporation chamber 14 may include a positive pressure chamber connector 52 for connecting the positive pressure pump 48 to the evaporation chamber 14 that comprises at least one hollow body having an interior and an exterior surface and at least one opening on said hollow body for forcing air into said evaporation chamber 14. The evaporation chamber 14 may also include an air outlet valve 42 configured to release the evaporated liquid, and a spray pump 44 that comprises at least one spray nozzle 46 for spraying the liquid generally directly onto the exterior surface 26 of the hollow body 22, such that the liquid evaporates due to elevated temperatures of the exterior surface 26 of the at least one hollow body 22. The control system 16 may include one or more sensors, automatic valves and a controller in operative communication with said one or more sensor 54, automatic valves 56, and positive pressure pump 48, whereby the control system 16 is configured to control operation of said heat exchanger 12, said positive pressure pump 48 and said evaporation chamber 14. The housing 18 may be configured to house the heat exchanger 12, the evaporation chamber 14, the positive pressure pump 48 and the control system 16. The apparatus can be also installed on another marine vessel or platform that is to be moored adjacent the marine vessel requiring disposal of the wastewater 11.

The apparatus 10 may alternatively be installed on any transportation vessel or vehicle, that has wastewater 11 that requires elimination. The apparatus 10 may evaporate any wastewater 11, such as marine, municipal or process wastewater.

Additionally, the apparatus may be installed in ground based systems requiring evaporation of wastewater or controlling temperature of the waste heat from a ground based engine.

The heat source may be an engine 33 of the marine vessel. and the heat may be an exhaust heat or a coolant from the engine.

The apparatus may also include a power source 20, for example, a generator.

Yet another embodiment of the present invention as seen in FIGS. 9-13 is directed towards an apparatus comprising a heat exchanger 12; an evaporation chamber 14; a control system 16; a housing 18 and a power source 20. The heat exchanger 12 of this particular embodiment may include at least one hollow body 22 defining a longitudinal axis of said heat exchanger 12, wherein the at least one hollowed body 22 has an exterior surface 26 and an interior surface 28, a first tapered opening 62 at a first end 32 of said at least one hollow body 22 that is configured to receive heat from a heat source, a second tapered opening 64 at a second end 36 of the at least one hollow body for expelling said heat, whereby said heat enters the first tapered opening 62 and flows through the at least one hollow body 22 in direct connection with the interior surface 28 of the at least one hollow body 22 and exits through to the second tapered opening 64, wherein said heat modulates temperature of both the interior surface 28 and the exterior surface 26 of the hollow body 22. Additionally, the at least one hollow body 22 includes a mounting flange 39 at each end of said hollow body 22 in operative alignment with a respective tapered opening 62, 64. The evaporation chamber 14 includes a vacuum pump 51, an input vacuum valve 53 that generates a vacuum in the evaporation chamber 14, an output vacuum valve 53 configured to release evaporated liquid, and a spray pump 44 that includes at least one spray nozzle 46 for spraying said wastewater 11 generally directly onto said exterior surface 26 of the hollow body 22, such that said liquid wastewater 11 evaporates due to elevated temperatures of the exterior surface 26 of the at least one hollow body 22. The control system 16 of this particular embodiment may include one or more sensors 54, automatic valves 56 and a controller 58 in operative communication with the one or more sensors 54, the automatic valves 56, and the input 53 and output 55 vacuum valves, whereby the control system 16 is configured to control operation of said heat exchanger 12 and the evaporation chamber 14. The housing 18, that can be provided as an open frame, houses the heat exchanger 12, the evaporation chamber 14, and the control system 16. The apparatus of the present embodiment may installed on a marine vessel. The heat source may be an engine 33 of the marine vessel. The heat may an exhaust heat or coolant from said engine.

An alternative embodiment of the present invention may be directed to a wastewater evaporation system 10 including an evaporation chamber 14; a heat exchanger 12 disposed within a hollow interior of said evaporation chamber 14; a means for spraying a wastewater 21 onto an exterior surface 26 of said heat exchanger 12, whereby a portion of a heat energy in a fluid circulated through a hollow interior 28 of the heat exchanger and transferred to an exterior surface 26 thereof converts the wastewater contacting said exterior surface 26 into vapors; and a means for evacuating said vapors from said evaporation chamber 14. The means for spraying the wastewater may be disposed within the evaporation chamber and may comprise a pump 44 and at least one nozzle 46 connected, in a fluid communication, to the pump 44. The wastewater evaporation system 10 of the present embodiment may also include a control system 16 configured to control an operation of the heat exchanger 12, the means for spraying the wastewater 21 and the evaporation chamber 14. Additionally, the wastewater evaporation system 10 may further include means for decreasing the temperature level required to convert wastewater into vapors, i.e., decreasing the boiling temperature of wastewater. The means for decreasing the temperature level required to convert wastewater into vapors may include utilizing the positive pressure created by a positive pressure chamber 47 and a means for connecting the positive pressure chamber with the evaporation chamber. The positive pressure chamber 47 of the present embodiment may also include a positive pressure pump disposed within the positive pressure chamber 47, an air inlet for receiving atmospheric air 49, a positive pressure outlet 50, and a connector 52 connecting said positive pressure outlet with an inlet in said evaporation chamber.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An evaporator system for evaporating wastewater, said evaporator system comprising:
a. an evaporation chamber;
b. a heat exchanger disposed within a hollow interior of said evaporation chamber and comprising:
i. at least one hollow body that has a wall with an exterior surface and an interior surface,
ii. a first opening at a first end of said at least one hollow body configured to receive a flow of a fluid therethrough,
iii. a second opening at a second end of said at least one hollow body configured to evacuate said flow of said fluid from said at least one hollow body, and
iv. whereby a portion of a heat energy in said fluid is transferred through said wall to said exterior surface thereof;
c. means for spraying the wastewater onto said exterior surface of said heat exchanger, comprising:
i. a spray pump,
ii. at least one spray nozzle, connected to said spray pump in a fluid communication therewith and configured to spray the wastewater onto said exterior surface of said hollow body,
iii. whereby the wastewater is converted into vapors upon a contact with said exterior surface of said wall due to said heat energy transfer, and
iv. wherein said vapors are evacuated from said evaporation chamber;
d. a control system comprising one or more sensors, automatic valves and a controller in operative communication with said one or more sensors, and said automatic valves, whereby said control apparatus is configured to control an operation of said heat exchanger, said means for spraying the wastewater and said evaporation chamber;
e. a housing for housing said heat exchanger, said evaporation chamber, and said controller; and
f. a power source.

2. The evaporator system of claim 1, wherein said fluid is one of an air and a liquid.

3. The evaporator system of claim 1, further comprising a positive pressure chamber, wherein said positive pressure chamber comprises:
i. a positive pressure pump,
ii. a positive pressure air inlet for receiving atmospheric air, and
iii. a positive pressure outlet.

4. The evaporator system of claim 3, further comprising a positive pressure chamber connector for connecting said positive pressure pump to said evaporation chamber, wherein said positive pressure chamber connector comprises at least one hollow body having an interior and an exterior surface and at least one opening on said hollow body for forcing air under pressure into said evaporation chamber.

5. The evaporator system of claim 1, wherein said evaporation chamber further comprises an evaporation chamber air outlet valve configured to evacuate said vapors.

6. The evaporator system of claim 1, wherein said at least one hollow body of said heat exchanger extends along a longitudinal axis of said heat exchanger, wherein said first opening of said hollow is a tapered opening, and wherein said second opening of said hollow body is a tapered opening.

7. The evaporator system of claim 6, further comprising a mounting flange at each end of said hollow body in an operative alignment with a respective tapered opening.

8. The evaporator system of claim 1, wherein said evaporation chamber comprises:
a. a vacuum pump,
b. an input vacuum valve that generates a vacuum on said evaporation chamber, and
c. an output vacuum valve to evacuate said vapors.

9. The evaporation chamber of claim 1, further comprising:
a. a positive pressure chamber, comprising:
i. a positive pressure pump,
ii. a positive pressure air inlet for receiving atmospheric air, and
iii. a positive pressure outlet; and
b. a positive pressure chamber connector for connecting said positive pressure pump to said evaporation chamber that comprises at least one hollow body having an interior and an exterior surface and at least one opening on said hollow body for forcing air under pressure into said evaporation chamber.

10. A vessel based system for treating and/or disposing marine wastewater, said system comprising:
a. an evaporation chamber;
b. a heat exchanger disposed within a hollow interior of said evaporation chamber and comprising:
i. at least one hollow body that has an exterior surface and an interior surface,
ii. a first opening at a first end of said at least one hollow body for receive waste heat energy from an engine on said vessel, and
iii. a second opening at a second end of said at least one hollow body, whereby said waste heat energy enters said at least one hollow body through said at least first opening, flows through said at least one hollow body in a direct connection with said interior surface and exits through said second opening, wherein said waste heat energy increases the temperature of both said interior surface and said exterior surface of said hollow body;
c. means for spraying the wastewater onto said exterior surface of said heat exchanger, comprising:
i. a spray pump, and
ii. at least one spray nozzle, connected to said spray pump in a fluid communication therewith, for spraying said wastewater generally directly onto said exterior surface of said hollow body, such that said wastewater evaporates due to elevated temperatures of said exterior surface of said at least one hollow body;
d. a positive pressure chamber, comprising:
i. a positive pressure pump,
ii. a positive pressure air inlet for receiving atmospheric air, and
iii. a positive pressure outlet;
e. a positive pressure chamber connector for connecting said positive pressure pump to said evaporation chamber that comprises at least one hollow body having an interior and an exterior surface and at least one opening on said hollow body for forcing air into said evaporation chamber;
f. an evaporation chamber air outlet valve configured to release said evaporated waste water;
g. a control system comprising one or more sensors, automatic valves and a controller in operative communication with said one or more sensors, said automatic valves, and said positive pressure pump, whereby said control system is configured to control operation of said heat exchanger, said positive pressure pump and said evaporation chamber;
h. a housing for housing said heat exchanger, said evaporation chamber, said positive pressure pump and said controller; and
i. a power source.

11. An apparatus comprising:
a. a heat exchanger comprising:
i. at least one hollow body that has an exterior surface and an interior surface,
ii. a first opening at a first end of said at least one hollow body that is configured to receive heat from a heat source, and
iii. a second opening at a second end of said at least one hollow body for expelling said heat, whereby said heat enters said at least one hollow body through said at least first opening and flows through said at least one hollow body in direct connection with said interior surface and exits through said second opening, wherein said heat modulates the temperature of both said interior surface and said exterior surface of said hollow body;
b. a positive pressure chamber, comprising:
i. a positive pressure pump,
ii. a positive pressure air inlet for receiving atmospheric air, and
iii. a positive pressure outlet;
c. an evaporation chamber, comprising:
i. a positive pressure chamber connector for connecting said positive pressure pump to said evaporation chamber that comprises at least one hollow body having an interior and an exterior surface and at least one opening on said hollow body for forcing air under pressure into said evaporation chamber,
ii. an evaporation chamber air outlet valve configured to release said evaporated liquid, and
iii. a spray pump that comprises at least one spray nozzle for spraying said liquid generally directly onto said exterior surface of said hollow body, such that said liquid evaporates due to elevated temperatures of said exterior surface of said at least one hollow body;
d. a control system comprising one or more sensors, automatic valves and a controller in operative communication with said one or more sensors, said automatic valves, and said positive pressure pump, whereby said control system is configured to control operation of said heat exchanger, said positive pressure pump and said evaporation chamber; and
e. a housing for housing said heat exchanger, said evaporation chamber, said positive pressure pump and said controller.

12. An apparatus of claim 11, being installed on a marine vessel, wherein said heat source is an engine of said marine vessel and wherein said heat is an exhaust heat or coolant from said engine.

13. An apparatus of claim 11, further comprising a power source, wherein said power source is a generator.

14. An apparatus comprising:
a. a heat exchanger comprising:
i. at least one hollow body defining a longitudinal axis of said heat exchanger, wherein said at least one hollowed body has an exterior surface and an interior surface,
ii. a first tapered opening at a first end of said at least one hollow body that is configured to receive heat from a heat source,
iii. a second tapered opening at a second end of said at least one hollow body for expelling said heat, whereby said heat enters said first tapered opening and flows through said at least one hollow body in direct connection with said interior surface of said at least one hollow body and exits through to said second tapered opening, wherein said heat modulates temperature of both the interior surface and the exterior surface of said hollow body, and
iv. a mounting flange at each end of said hollow body in operative alignment with a respective tapered opening;
b. an evaporation chamber comprising:
i. a vacuum pump,
ii. an input vacuum valve that generates a vacuum in said evaporation chamber,
iii. an output vacuum valve configured to release evaporated liquid, and
iv. a spray pump and at least one spray nozzle operatively connected thereto for spraying said liquid generally directly onto said exterior surface of said hollow body, such that said liquid evaporates due to elevated temperatures of said exterior surface of said at least one hollow body;
c. a control system comprising one or more sensors, automatic valves and a controller in operative communication with said one or more sensors, said automatic valves, and said input and output vacuum valves, whereby said control system is configured to control operation of said heat exchanger and said evaporation chamber;
d. a housing for housing said heat exchanger, said evaporation chamber, and said control system; and
e. a power source.

15. An apparatus of claim 14, being installed on a marine vessel, wherein said liquid is a marine wastewater, wherein said heat source is an engine of said marine vessel and wherein said heat is an exhaust heat or coolant from said engine.

16. A wastewater evaporation system comprising:
a. an evaporation chamber,
b. a heat exchanger disposed within a hollow interior of said evaporation chamber,
c. a means for spraying a wastewater onto an exterior surface of said heat exchanger, whereby a portion of a heat energy in a fluid circulated through a hollow interior of said heat exchanger and transferred to an exterior surface thereof converts the wastewater contacting said exterior surface into vapors; and
d. a means for evacuating said vapors from said evaporation chamber.

17. The wastewater evaporation system of claim 16, wherein said means for spraying the wastewater is disposed within said evaporation chamber and comprises a pump and at least one nozzle connected, in a fluid communication, to said pump.

18. The wastewater evaporation system of claim 16, further comprising a control system configured to control an operation of said heat exchanger, said means for spraying the wastewater and said evaporation chamber.

19. The wastewater evaporation system of claim 16, further comprising a means for decreasing a temperature level required to convert the wastewater converts into said vapors.

20. The wastewater evaporation system of claim 19, wherein said means for decreasing said temperature level comprises: a positive pressure chamber and a means for connecting said positive pressure chamber with said evaporation chamber, wherein said positive pressure chamber is operable to decrease a temperature at which the wastewater converts into said vapors.

21. The wastewater evaporation system of claim 20, wherein said positive pressure chamber further comprises:
i. a positive pressure pump disposed within said positive pressure chamber,
ii. an air inlet for receiving an atmospheric air, and
iii. a positive pressure outlet, and
iv. a connector connecting said positive pressure outlet with an inlet in said evaporation chamber.
